(19) United States
(12) Patent Application Publication
(10) Pub. No.: US 2003/0232618 A1
(43) Pub. Date: Dec. 18, 2003

(54) System and method for implementing virtual mobile messaging services

(75) Inventors: Vui Le, Cypress, TX (US); Man Nguyen, Houston, TX (US); Tao Vu, Houston, TX (US)

Correspondence Address: HAYNES AND BOONE, LLP, 1000 LOUISIANA, SUITE 4300, HOUSTON, TX, 77002, US

(73) Assignee: Vuico, L.L.C., Houston, TX (US)

(21) Appl. No.: 10/388,878

(22) Filed: Mar. 14, 2003

Related U.S. Application Data
(60) Provisional application No. 60/387,928, filed on Jun. 12, 2002.
(60) Provisional application No. 60/387,962, filed on Jun. 12, 2002.
(60) Provisional application No. 60/388,169, filed on Jun. 12, 2002.

(51) Int. Cl. H04M 11/10

(52) U.S. Cl. 455/412.2; 455/412.1

(57) ABSTRACT

According to one embodiment, a wireless mobile messaging system architecture includes a virtual mobile messaging service (VMMS) client, a virtual mobile messaging system (VMMS) component, and a middleware server component. The VMMS client is adapted to run on a Java-enabled mobile device, the client including a user interface and a lightweight object request broker (ORB), wherein the user interface enables input of a client request to a messaging server. The VMMS component includes an enterprise Java beans (EJB) component and a mobile messaging server agent, wherein the EJB component is configured to operate on the Java application server to handle the client request to the messaging server via the mobile messaging server agent, and the mobile messaging server agent is configured to interface with the messaging server. Lastly, the middleware server component is adapted to support distributed object-oriented connectivity from the Java-enabled mobile device to the EJB component on the Java application server, the middleware component including a gateway server adapted to support transparent access from the Java-enabled mobile device to the EJB component on the Java application server, and wherein the lightweight ORB enables communication between the client on the Java-enabled mobile device and the middleware server component on the Java application server.

This application claims the benefit of the earlier filed provisional applications Ser. No. 60/387,962, filed Jun. 12, 2002; Serial No. 60/387,928, filed Jun. 12, 2002; and Ser. No. 60/388,169, filed Jun. 12, 2002, incorporated by reference herein in their entirety. Copending application, Attorney docket 32498.27, entitled “SYSTEM AND METHOD FOR IMPLEMENTING COMMUNICATION MIDDLEWARE FOR MOBILE “JAVA” COMPUTING” and assigned to the present assignee, filed concurrently herewith, is incorporated herein by reference in its entirety.

### BACKGROUND

The present disclosure relates generally to mobile communication systems, and more particularly to a system and method for implementing virtual mobile messaging services.

Cellular phones were initially developed for the purpose of voice telecommunications, however, recent technical innovations (wireless-communications technology, Internet technology, and especially hardware integration technology) have positioned it as an important information tool. For example, some of the newest cellular phone models have the capability of running Java applications. With such Java-enabled cell phones, diverse types of JavaTM applications, like games (action, adventure, etc.), entertainment programs (karaoke), and business applications (stock information, online trading, etc.) are being developed and used. However, the hardware resources of such cellular phones are very limited.

In order to develop highly functional and useful applications capable of running on such mobile platforms and to compensate for the resource limitation, a close collaboration between the mobile devices and server side applications through a network is needed. A communications capability is vital for such mobile Java applications. Accordingly, communications is a key, issue for improving the attractiveness of mobile Java applications on platforms that assume wireless connections.

Currently, there exist a number of forces acting in a kind of tug-of-war to shape the wireless market. Each of these forces is entrenched and unlikely to disappear soon. A first force includes demand for more advanced wireless services and applications that will enhance and improve people's lives at home and at work. A second force includes competing technology platforms and communication formats that are not interoperable and cause delays in rolling out truly useful new mobile applications and services.

Several issues in the wireless market are influenced by these forces and affect carriers, handset providers and enterprises both alike and in different ways. One issue involves a need for new services and revenue sources. Carriers are seeking service ideas and technology that can raise average revenue per unit (ARPU) from their enterprise customers. Such applications generally do not exist and are often difficult to deploy. Enterprises are seeking more effective ways to enhance employee productivity through more intelligent technology applications. Another issue includes a need to make more efficient use of available bandwidth. Bandwidth is currently at or near capacity, with next generation bandwidth still in the future. Yet another issue is a need for standardized software and applications. There is significant technological confusion in the marketplace that causes both uncertainty and increased carrier costs. This confusion causes both carriers and enterprises to be more hesitant about making large-scale investments in what they may perceive to be short-lived technology.

Still another issue is a need for “anywhere” and “anyhow” access to corporate data. Employees are increasingly mobile and require access to corporate information from wherever they are and whenever they need it. PC's are not always available and wireless devices must be able to communicate with corporate applications, including electronic mail and groupware. Still yet another issue is a need for more cost effective devices. Device makers want to standardize on technology that is long-lived, provides consistent user interfaces, and is cost-effective.

Accordingly, it would be desirable to provide an innovative, cost-effective architectural solution for overcoming the problems in the art as discussed above.

### SUMMARY

According to one embodiment, a wireless mobile messaging system architecture includes a virtual mobile messaging service (VMMS) client, a virtual mobile messaging system (VMMS) component, and a middleware server component. The VMMS client is adapted to run on a Java-enabled mobile device, the client including a user interface and a lightweight object request broker (ORB), wherein the user interface enables input of a client request to a messaging server. The VMMS component includes an enterprise Java beans (EJB) component and a mobile messaging server agent, wherein the EJB component is configured to operate on the Java application server to handle the client request to the messaging server via the mobile messaging server agent, and the mobile messaging server agent is configured to interface with the messaging server. Lastly, the middleware server component is adapted to support distributed object-oriented connectivity from the Java-enabled mobile device to the EJB component on the Java application server, the middleware component including a gateway server adapted to support transparent access from the Java-enabled mobile device to the EJB component on the Java application server, and wherein the lightweight ORB enables communication between the client on the Java-enabled mobile device and the middleware server component on the Java application server.

### BRIEF DESCRIPTION OF THE DRAWINGS

FIG. 1 is a block diagram view of a wireless mobile messaging architecture according to one embodiment of the present disclosure;

FIG. 2 is a block diagram view of the wireless mobile messaging architecture according to another embodiment of the present disclosure;

FIG. 3 is a block diagram view of a software configuration layer of the wireless mobile messaging architecture according to another embodiment of the present disclosure;

FIG. 4 is a flow diagram view of a user interface and process flow of various modules of the user interface in the wireless mobile messaging architecture according to one embodiment of the present disclosure; and

FIG. 5 is an exemplary display screen view of various display screens on a mobile device operable with the wireless mobile messaging architecture according to one embodiment of the present disclosure.

### DETAILED DESCRIPTION

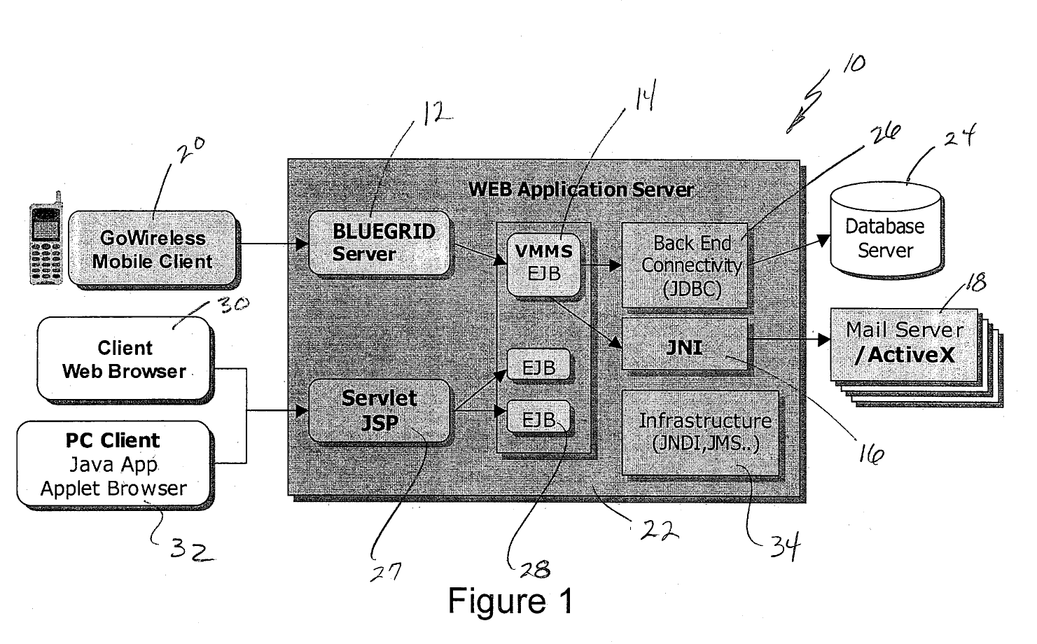

Referring now to FIG. 1, according to one illustrative embodiment, a software architecture for implementing the wireless mobile messaging system 10 includes a BlueGridTM server software 12, virtual mobile messaging service EJBs 14, a Java Native Interface (JNI) or JaWin DLL 16, a mail server ActiveX DLL or agent 18, and a wireless mobile client application package 20. Installing of the wireless mobile messaging system 10 on an application server 22 includes deploying the virtual mobile messaging service access EJBs 14 and registering the DLLs for corresponding mail messaging servers 18. The web application server 22 also includes a database 24 configured to store user profile information, the database having an object database connectivity (ODBC) or Java database connectivity (JDBC) 26 system data source name that points to the database. The web application server 22 can also be configured to support the use of a servlet JSP 27 and EJB 28 in connection with a client web browser 30 and a PC client Java Applet browser 32. Web application server 22 further includes infrastructure 34 (JNDI, JMS, . . . ) as may be required for a particular implementation.

Various functionalities of the virtual mobile messaging services (VMMS) application of the present disclosure shall be briefly described herein below. Goals of the VMMS application include one or more of: reducing memory requirements of the VMMS client midlet (Mobile Information Device Applet) to support 2.5G phones (on the order of less than 30K bytes); supporting MIDP handsets, providing full mail service functions (e.g., mail, schedule, task, note, and contacts); and supporting common mail servers (e.g., MS Exchange, Note and POP3).

The VMMS operating environment of the present disclosures can be configured to support access to various mobile messaging server systems, for example, Microsoft Exchange, IBM Lotus Domino, Novell GroupWise, or any other mail system that supports standard POP3/IMAP4 and SMTP protocols. The VMMS operating environment also utilizes a Relational Database Management System (RDBMS) that supports SQL and JDBC/ORBC, a J2EETM compliant application server, a Servlet environment, a EJB environment, JAVA/Win32 (JAWIN), and BlueGrid Java Communication Middleware. J2EE means JavaTM 2 Platform, Enterprise Edition and includes an environment for developing and deploying enterprise applications. JAWIN refers to the interoperation between Java and a component exposed through Microsoft's Component Object Model (COM) or through Win32 Dynamic Link Libraries (DLL).

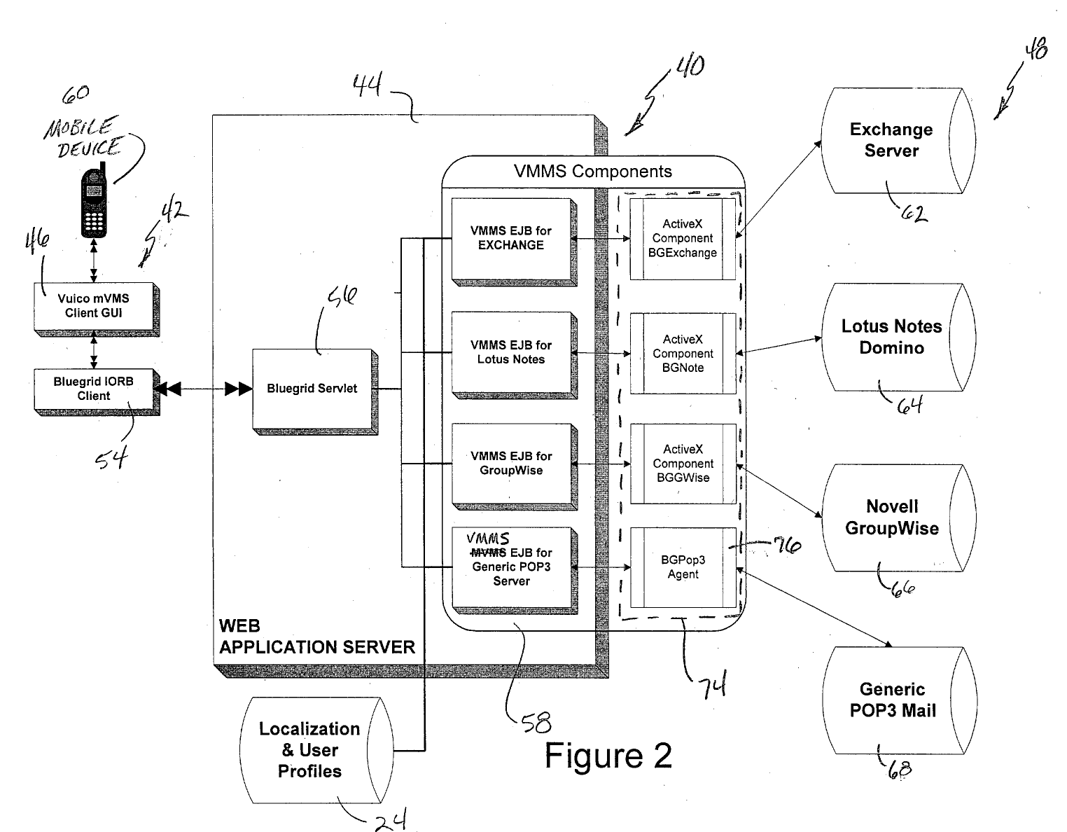

Turning now to FIG. 2 (VMMS Physical Layout), a block diagram view of the virtual mobile messaging system (VMMS) architecture 40 according to another embodiment of the present disclosure and its external dependency components shall be discussed.

Component Data Flow Scenarios

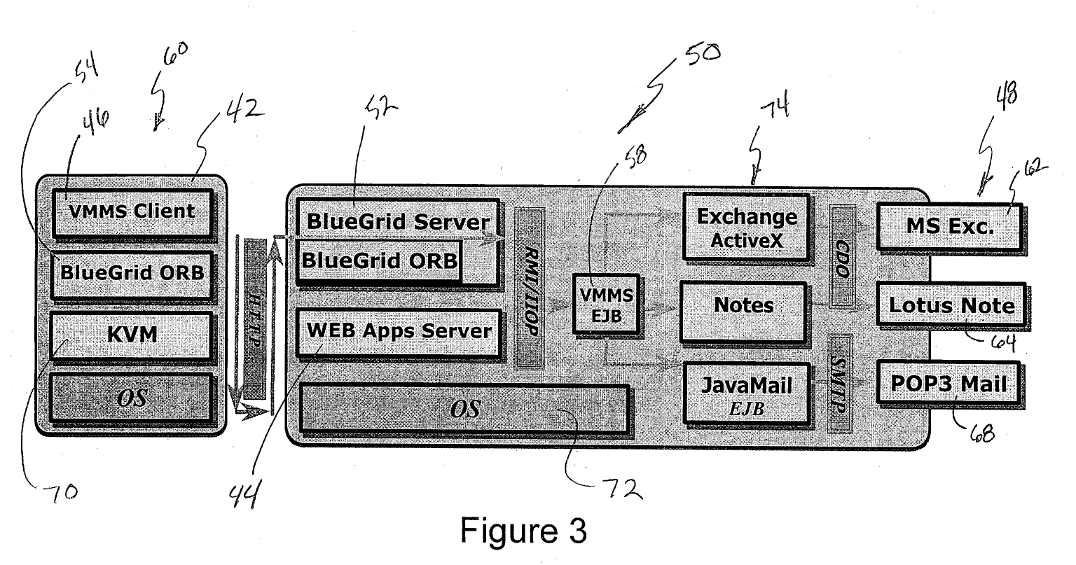

As a client-server application, there are two main components in the virtual mobile messaging system (VMMS) 40 which include a VMMS client 42 and a VMMS server 44. The VMMS Client is a lightweight client to handle the user interface (UI) 46. The VMMS Server is a gateway server that allows mobile client applications to make direct accesses to the desired mail server(s) 48. FIG. 3 (VMMS Software Configuration Layer) is a components diagram 50 of the VMMS application, which contains both client 42 and server 44 of VMMS 40 and its external dependency software components.

In connection with the VMMS software configuration layer 50 of FIG. 3, data flow of the VMMS application is carried out with the use of multiple protocols and formats. The following table summarizes protocols and formats, for use when passing data from one component to another in the VMMS application, according to one embodiment.

VMMS data flow protocols and format

| | Protocols | Data Format |
|---|---|---|
| VMMS Client | | |
| BlueGrid Servlet | HTTP/HTTPS | String byte array |
| VMMS EJB | RMI/IIOP | String |
| JAWIN DLL | JNI DLL | Java Object |
| VCMM ActiveX (VB DLL) | C Function library call | C Object |
| Mail Server (Exchange) | CDO | COM Object |

### VMMS Data Flow Protocols and Format

Client Components.

According to one embodimentt, the VMMS client application 42 is loaded and executed from a J2METM MIDP profile device. In another embodiment, a J2ME/CLDC profile is used. With respect to the J2ME/CLDC profile, because of limited resources in J2ME/CLDC mobile devices, in particular, 2.5G phones, the VMMS client application 42 size must be less than 30K bytes. J2ME means Java 2 Platform, Micro Edition and includes a group of specifications and technologies that pertain to Java on small devices. J2ME covers a wide range of devices, from pagers and mobile telephones through set-top boxes and car navigation systems.

The client application 42 contains two main components. The Mobile Client component 46 is a Java based application, which runs on the mobile device to handle the user interface and enable the communication with the BlueGrid-Server 52 through the BlueGrid-ORB 54. The BlueGrid-ORB 54 Client component is a Mobile Java Communication middleware to handle the application HTTP/HTTPS communication with the BlueGrid-Server 52. Hypertext Transfer Protocol (HTTP) is an Internet protocol used to fetch hypertext objects from remote hosts. HTTP messages consist of requests from client to server and responses from server to client. In addition, Secure Sockets Layer (SSL) is a protocol for transmitting private documents via the Internet. SSL works by using a public key to encrypt data that's transferred over the SSL connection. Accordingly, HTTPS messages consist of requests from client to server and responses from server to client that require an SSL connection.

Server Components

The VMMS server components are run on the application server 44. Their main function is to provide access to the desired mail service(s) 48 to/from the VMMS client 42. There are three main server components. A first component includes a BlueGrid-Server 52, which runs as a servlet 56 (FIG. 2) and offers a gateway feature between a BlueGrid-ORB client 54 and an Enterprise Java Bean (EJB) 58. Accordingly, the Bluegrid server 52 allows the J2ME/CLDC application of the mobile device 60 to access the EJB components 58. The VMMS EJB component(s) 58 handles client requests. That is, the EJB component 58 receives the user's request from BlueGrid servlet 56 in the string format. The BlueGrid servlet 56 converts the string request to a Java object and sends the request object to the JaWin DLL through JNI (Java Native Interface) 16 (FIG. 1). JaWin DLL passes the request to the VMMS ActiveX 18 (FIG. 1). JaWin DLL converts received Java objects to C objects and calls the VMMS CLIENT ActiveX 18 (FIG. 1) through a C function call. The VMMS CLIENT ActiveX 18 sends the request to mail server 48 (e.g. an MS Exchange server 62). The VMMS CLIENT ActiveX 18 converts the received C object to a DOM object, and sends the request object to the mail server 48.

Multi-User Support

The VMMS 50 includes a client-server architecture application that operates under a J2EE environment. The VMMS 50 will support multi-user interaction, since its operating environment and its DLL are supported multiple threaded. Multiple users can access the VMMS application 50 at the same time.

Localization Issues

In one embodiment, the user interface (UI) 46 is written for a J2ME MIDP profile and supports the English language. The user interface (UI) can also be configured to support other languages and profiles.

Security Considerations

According to another embodiment, security is a requirement in many aspects of the VMMS client server application 50 product. The MIDP profile version and Java version are selected to support SSL. In addition, the VMMS is configured to support HTTPS protocol.

Referring again to FIG. 2, WEB Application Server 44 may include any suitable web application server, for example, but not limited to: BEA WebLogicâ Application Server; IBM WebSphereâ Application Server; Javaä 2 Platform, Enterprise Edition Server; Oracle 9iâ Application Server; Sun Microsystems iPlanetâ Application Server; or other suitable server.

Mails Servers 48 can include any suitable mail servers, for example, but not limited to: Microsoftâ Exchange Server 62; IBMâ Lotus Dominoâ Mail Server 64; Novell GroupWiseâ 66; Mail Server systems that support POP3/SMTP 68; and Mail Server systems that support IMAP/SMTP.

According to one embodiment, the wireless mobile platform and mobile messaging architecture operate as follows. Wireless devices, such as a handset or PDA 60 contain two code sets. The first code set is the wireless mobile client 42 and the second is software unique to each application that must run on the wireless device. The wireless mobile client is the software that enables all communications with the BlueGrid server and beyond to the messaging server application, such as MS ExchangeTM. The wireless mobile client 42 is very small, requiring on the order of approximately 2-8K of device memory. In one embodiment, the wireless mobile client 42 is burned into the device chipset of a respective wireless device. In another embodiment, the wireless mobile client 42 is downloaded by a carrier or the mobile device manufacturer to the device memory of the wireless device, for example, from a website or via an over-the-air provisioning program.

One advantage of the wireless mobile client 42 of the VMMS architecture 40 is its simplicity. Rather than requiring wireless devices with limited memory and processor speed to assume the full functionality of J2ME, the wireless mobile platform relegates most of the J2ME processing to the BlueGrid server 12 (FIG. 1). The wireless devices are left to focus on their respective unique functionality. Accordingly, this provides a performance, maintainability, and cost-benefit to the wireless device manufacturer and its customers.

According to one embodiment, the wireless mobile client 42 includes an Object Request Broker (ORB) 54. The ORB 54 of the wireless mobile client communicates with a BlueGrid ORB running on the BlueGrid server 52. The wireless mobile client ORB 54 also utilizes a MIDP (mobile information device profile) and Java KVM (Sun Microsystem Java's Virtual Machine) software that are pre-configured to operate and already present and operational on the wireless mobile device 60. In addition, on top of the wireless mobile client resides software unique to each application that runs on the wireless mobile device (to be discussed further herein below).

With respect to wireless mobile messaging according to one embodiment of the present disclosure, the wireless mobile messaging application resident on the wireless device or handset 60 includes a GUI 46 and dialog. The GUI 46 and dialog are necessary to retrieve or develop and send information such as email, calendar information, etc. The GUI and dialog of wireless mobile messaging applications require on the order of about 25K of device memory on the wireless device, which is much less than browser-based application, and furthermore, much less than browsers themselves. In addition, the wireless mobile messaging applications enable browsing through multiple remote, over-the-air menus. Because browsing through multiple remote, over-the-air menus is utilized, sending and receiving information is much quicker and uses much less network bandwidth. The wireless mobile messaging software on the wireless mobile device also runs in binary fashion, requiring much less data translation than browser-based systems need.

The BlueGrid servlet 56 is a communications point for the wireless client software of the wireless mobile device 60. The BlueGrid servlet 56 includes an ORB that communicates with the client ORB 54 and the Java Virtual Machine (JVM) software 70 (FIG. 3) of the wireless mobile device 60. The JVM software 70 is core Java software required by Java servers. The BlueGrid servlet 56 runs on any web applications server and resides atop the respective web application server's operating system 72.

In one embodiment, the BlueGrid servlet 56 handles what used to be required on limited-capacity wireless devices, that is, in connection with the J2ME specification (Java 2 Mobile Environment). Note that the J2ME specification is very robust. With respect to prior limited-capacity wireless devices, placing all the J2ME required code on a handset, for example, proved to be sometimes impossible, and furthermore, very often too taxing for the handset's processor. In connection with the wireless mobile architectural model of the present disclosure, much of the J2ME processing is moved onto the BlueGrid servlet 56, accordingly, leaving the client 42 of the mobile wireless device 60 as thin as possible.

Further in connection with the wireless mobile platform of the present embodiments, the wireless mobile platform 40 includes an EJB backend (14, 58) configured to communicate with the corresponding server based messaging application 48. In one embodiment, the EJB backend 58 communicates with an ActiveX application 74 residing on a respective messaging application server platform 48. The ActiveX component 74 includes API's necessary to move data between the messaging application of the messaging server 48, the BlueGrid middleware 52, and ultimately, the wireless device 60. Since many Microsoft applications, as well as other messaging applications, do not communicate directly with Java, but instead employ ActiveX, the EJB code 58 is configured to translate Java to ActiveX. Accordingly, the EJB code allows the communications with the specific application to occur more naturally. In the case where ActiveX is not required, according to one embodiment, the wireless mobile architecture includes an application-specific agent 76 configured to be run on the messaging application's server platform. In another embodiment, a single agent 74 can be configured to act as a gateway agent for more than one messaging server, as indicated by the dashed box in FIG. 2.

In addition to the agent 74 residing on the messaging application's server, the wireless mobile architecture includes XML to EJB software. The XML to EJB software takes XML data from the wireless mobile device and places it in a format required by the EJB software. The EJB software provides a Java front-end to the messaging application (e.g., Exchange 62), in connection with the ActiveX component or agent as discussed above. In reverse, the XML to EJB software takes the EJB data and converts it to appropriate XML data.

According to another embodiment, the wireless mobile messaging architecture provides performance, flexibility and ease of expansion of capabilities. For example, the wireless mobile messaging architecture can be used to implement a wireless mobile messaging application, such as, Exchange 62, Notes TM 64, GroupWise TM 66, and POP3 68.

Since the wireless mobile messaging architecture is server-powered, it provides a full set of messaging capabilities. For example, the messaging capabilities can include read, compose, reply, reply all, and forward. The messaging capabilities can also include corporate address look-up, cut and past into address fields, allowing no need to type in email addresses. Still further, the messaging capabilities can include access to the wireless device's local address book, however, such additional messaging capabilities may need to be accomplished via device-specific modifications, further including security considerations.

The wireless mobile messaging architecture can also provide calendaring capabilities. Calendaring capabilities include, for example, an ability to view and schedule meetings with other users of the server-based or network messaging application, to-do's and lists. The wireless mobile messaging architecture leverages the strengths of the network and the applications servers on which the messaging applications run.

In connection with the wireless mobile architecture of the present disclosure, additional security features for the mobile device can also be provided. Such security features may include, for example, a session timeout so that for a mobile device which has been left on and unattended, email cannot be downloaded, nor calendars viewed on the network. In addition, email and other information is not retained once the mobile device is turned off, accordingly, preventing any unauthorized access to that information if the mobile device becomes lost or stolen.

The wireless mobile architecture of the present disclosure facilitates performance features that can include, for example, the use of thin client devices which minimizes network traffic, enables fast response times over the network, ability to support large enterprise users or subscribers, and a substantially direction connection to the network server-based messaging application.

The wireless mobile architecture further provides usability features that include, for example, direct connect with no need to sync, no sync problems, mail, address books always available, and no need for any SyncML (SyncML is an emerging XML-based standard for synchronizing devices and applications over a network). The wireless mobile architecture eliminates information synchronization across management devices. The mobile messaging architecture GUI for the wireless device more closely reflects a typical session of a corresponding server-based messaging application, resulting in the GUI being easy to learn and use. Other usability features include simple cut and past for inserting address book entries in email address lines, and the use of full color capabilities when available on the handset, such as color graphics for a monthly calendar view.

Unlike other wireless email systems, the wireless mobile messaging system according to one embodiment of the present disclosure provides a secure, direct connection to a server-based messaging application system, such as a corporate system. No synchronization is required between a user's mobile handset or wireless device and the user's PC. Furthermore, no synchronization software is required on the user's PC.

For mobile devices having address books, synchronization is well suited for populating the address books from tethered PC's or wireless portals, however, not for email. In addition, synchronization presupposes that the synchronized elements are to remain on the handset which creates a security problem if the handset is lost or stolen. Synchronization also requires handset driver software, which makes it difficult to acquire new handsets and obtain its numerous benefits if appropriate software has not been released. Lastly, synchronization sessions often prematurely abort, leaving the mobile device in an indeterminate state in which it is unclear to the user which emails were synchronized and which ones were not. This can result in duplicate or missing emails on the mobile device. The wireless mobile architecture according to the present disclosure does not suffer from any of these synchronization problems and, accordingly, provides full functionality of a respective server-based messaging application without synchronization problems.

A number of wireless corporate email access products require re-direct software on user's PCs. The re-direct software adds another dimension of complexity and configuration to corporate information technology (IT) staff. However, the wireless mobile architecture of the present disclosure does not require such re-direct software on a user's PC. The software of the wireless mobile architecture resides in the client GUI and/or on the wireless mobile architecture application server. Accordingly, the software can be cleanly managed by the corporate IT staff or the service provider, depending on the particular implementation. In addition, the end user need not worry if a PC is on or off, or if software is loaded or not. Furthermore, the end user also does not have to worry if he/she redirected emails to the wireless device or not.

In addition to the above, it is noted that browser-based wireless messaging systems have their own set of problems. For example, all menuing is host-based. That is, the end user selections must go to the web server and be acted upon before the first email or calendar item is retrieved from the server-based messaging application. In contrast, the mobile messaging client resident on the wireless device of the wireless mobile architecture of the present disclosure handles all menuing internally on the mobile device. The mobile messaging client only sends the final command to the email host (with no web server in the middle) to make more work for the user or add additional overhead to the network.

Accordingly, the wireless mobile messaging platform of the present disclosure offers advantages that other wireless technologies can not. The advantages provide solutions to major problems that are making it difficult for wireless carriers, device makers, enterprises and wireless solution providers to deliver “real” wireless Internet solutions the offer a very satisfying yet very secure Internet experience to their subscribers and mobile users.

Additional advantages of incorporating the wireless mobile architecture into a wireless services technology base include: taking advantage of advanced wireless network capabilities; providing foundation software and architecture suitable for meeting next generation wireless applications and features, such as videophones, and voice command operation; building to a global standard, making global markets more accessible; and minimizing the need for carriers to install and maintain a very expensive network infrastructure, while being able to offer new and useful revenue-generating wireless Internet and m-Commerce services to subscribers.

According to another embodiment, the wireless mobile messaging application software configuration layer includes a number of components as follows. A mobile messaging client interface is provided on the mobile device or handset to manage the messaging presentation. In particular, the handset includes a java enabled device, with KVM/MIDP and a BlueGrid ORB. BlueGrid Gateway Components are provided on a web application server to manage and process all requests from the mobile device and is configured to interface with the BlueGrid Server. A Java to messaging service utility or agent (e.g., Java to MS Exchange) converts Java requests to messaging service compliant requests of a corresponding messaging server. The utility also interprets Java and messaging service calls. In one embodiment, the Java to messaging service utility is implemented in the form of a RPC (remote procedure call). Lastly, the messaging server serves and stores messages and other information. For example, one illustrative messaging server includes any data center or server running standard MS Exchange, with no modification to MS Exchange needed.

Further in connection with one embodiment of the present disclosure, mobile messaging clients are created to support a corresponding messaging server. For example, in a suite of wireless mobile messaging software products that includes access to one or more of a Microsoft Exchange server 62, a LotusTM DominoTM server 64, a GroupWiseTM server 66, and a mobile POP3 mail server 68, a corresponding mobile messaging client is provided. The mobile messaging clients include a wireless Exchange mobile messaging client, a wireless Notes mobile messaging client, a GroupWise mobile messaging client, and a mobile mail server messaging client, respectively. In one embodiment, the wireless mobile application package containing the corresponding mobile messaging clients can be delivered to appropriate web application servers for installation thereon via a CD-ROM or via web/FTP sites.

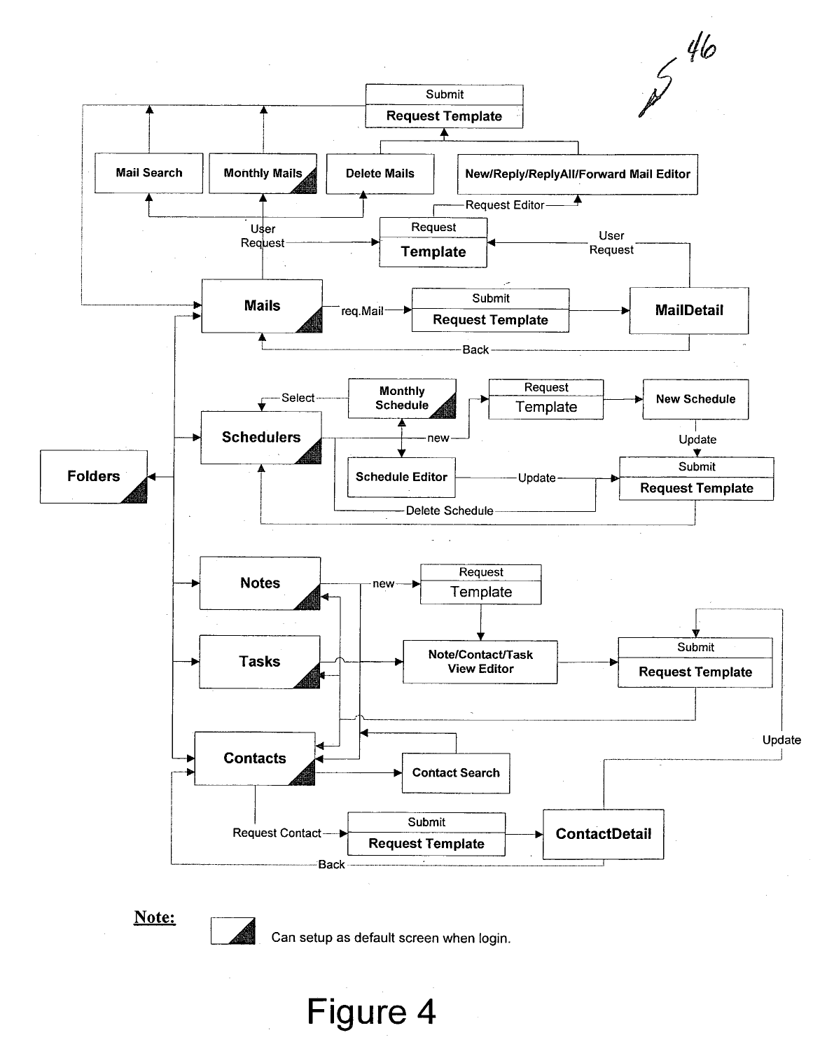

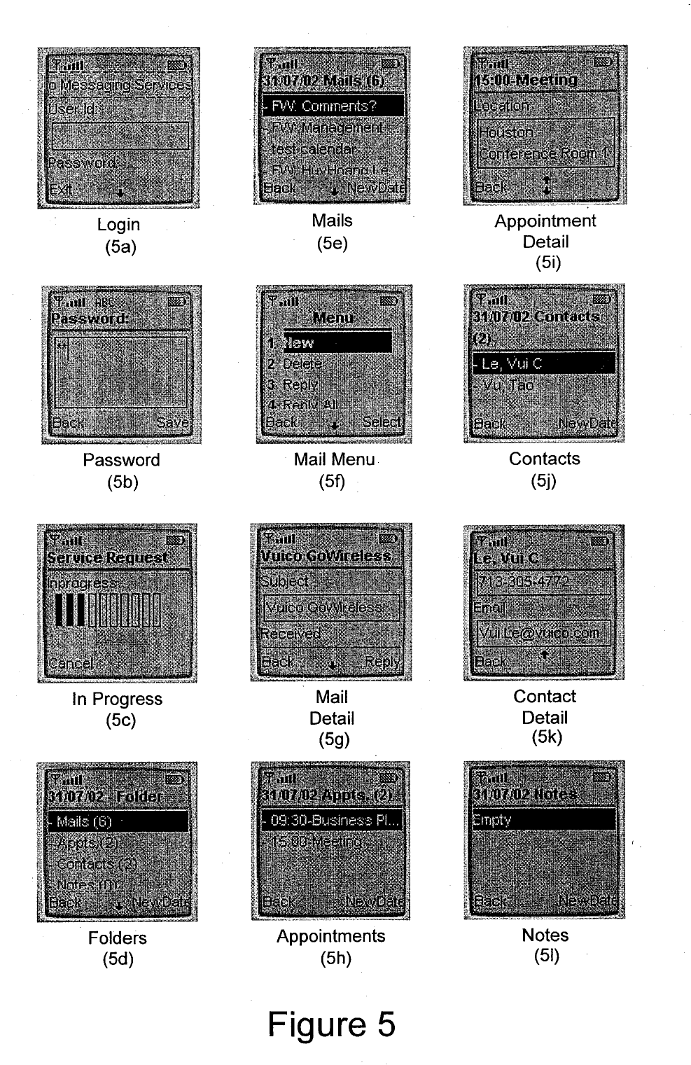

Referring now to FIGS. 4 and 5, FIG. 4 illustrates one embodiment of a user interface (UI) 46 process flow, the UI being resident upon the mobile device 60 for implementation of mail services according to the embodiments of the present disclosure. FIG. 5 shows example screen views on the mobile device corresponding with the UI process flow of FIG. 4.

Features Breakdown

To illustrate one example of a features breakdown, the process begins with a login sequence at a Login Screen (Login Screen and Enter Password of FIGS. 5a and 5b, respectively). Responsive to loading of the VMMS client midlet at the mobile device, a Login Screen is displayed upon the device's display. The login screen includes a request for the device user to enter a username and password. That is, the mobile device user is requested for entering his/her user name and password to login to the mail server. Responsive to receiving the requested username and password input, the VMMS midlet sends the login request to the mail server (e.g., an Exchange Server). In response to receiving the login request, the Exchange mail server returns a run-time User's ID to the VMMS client. The User's ID will be either 0 (cannot login) or an integer greater than 0 (successful). The VMMS client will use this ID as user's reference on the future requests.

During a processing of a service request, the client server communication in progress, that is, an “In Progress” screen, FIG. 5c, (In Progress Screen) will be displayed on the mobile device display screen. The mobile device user can cancel the current process by selecting and/or pressing the CANCEL button.

In response to a successful Login, the VMMS client requests a next screen, for example, a default screen for displaying the current date (FIG. 5d). The mail server retrieves the user's properties and returns the last requested summary folder. If the last requested summary is invalid, then the mail server returns a Folder Summary screen for displaying.

According to one embodiment, to provide support for a mobile device user's UI (user interface) configuration, each user will have his/her own user profile that stored in a server database of the wireless mobile messaging server architecture. The user's profile properties are setup during a user registration process. For example, the configuration properties can include one or more of: FolderRequest, BufferSize, Domain, ExchangeFolder (in the case of a MS Exchange mail server), MailFetchLimit, MemorySize, and SendAlert. FolderRequest corresponds to the last packet summary requested by the user. BufferSize refers to the maximum number of bytes allowed in a content field. Domain refers to the user's domain. ExchangeFolder refers to a user's MS Exchange directory. MailFetchLimit defines a maximum number of mails to be returned from the mail server. MemorySize refers to the client device's available memory to determine a maximum number of items that can be returned to the client at a given time. Lastly, SendAlert enables appointment and mail alert notification to the client residing on the mobile device or handset.

Folders Summary:

The folder summary is a default screen for a first-time user. The folder summary shows the list of available folder(s) that belong to the login user. Attached to the folder name is a count of available items in the folder. The folder summary, FIG. 5d, (Folder Screen) shows that the login user folder currently contains 6 mails, 2 appointments, 2 contacts and no Notes. In the example Folder Screen of FIG. 5d, the Mails count is only for a selected day, for example, as a default for the current date. The Appointments count is only for a selected day, for example, as a default for the current date. The Contacts and Notes count are for all existing items in respective categories. Similarly, a Tasks count includes tasks for a selected day. Selecting the Date button enables a user to choose a different date. Similarly, selecting the Back button enables a user to go back to a previous screen, for example, the login screen.

Mail Summary Listing (FIG. 5e—Mail Summary Screen):

A header of the Mail Summary Screen will show the selected date and how many mails exist for this date, based on the received time. The mail(s) are listed in the order of received time: most recent first. For each mail entry, only the mail subject is shown, its content is truncated to fit into 1 line on the screen. All other associated data are hidden from the user. In one implementation, all received mails on the selected date are fetched and displayed. For other implementations of the wireless mobile messaging architecture, the application returns the MailFetchLimit number of the most recent mails. If the number of a selected date's mail(s) is greater than the MailFetchLimit, the application will return entire list instead of the MailFetchLimit number. However, the number of return mail items size must be smaller than the client available memory size (MemorySize property).

The VMMS client also provides for User Navigation. User Navigation begins by moving a highlighted cursor on the mobile device display to a desired mail to mark it as a selected mail. A user next selects the ENTER button (e.g., a green phone icon on the mobile device) to display the detail of the highlighted mail item. Additional options, for example, as shown in FIG. 5f, include selecting a desired MENU button to: Create New Mail; Delete Selected Mail; Reply to Selected Mail; Reply All to Selected Mail; Forward Selected Mail; Search Mail; and Exit application. In one embodiment, the VMMS client can be configured to show which mail has been read already. In addition, in another embodiment, the VMMS client can be configured to distinguish Read and Un-read mails. Still further, the VMMS client can be configured with an ability for the mobile device user to filter (search) for emails based on date, subject and sender.

Mail Details Listing (FIG. 5g—Mail Detail Screen):

In one embodiment, the mail's details page displays fields such as: subject, from (sender name), to, cc and content. The bcc field is not shown. Each display field has two components, i.e., a header and content. The content field is limited to a number of bytes of a “BufferSize” property. In one embodiment, the VMMS client supports TEXT only for the mail details screen. In another embodiment, the VMMS client is configured to support both TEXT and HTML in the mail detail listing.

Create Mail:

When a user requests for new mail, the VMMS client fetches the template for new mail from the VMMS server via packet protocol and displays the template for user's input. The VMMS server then builds the template. A template field can be added or changed at the Server's side. The new template will then be displayed properly on the VMMS client dynamically. One new mail template can include five (5) fields to be shown: i.e., subject, to, cc, bcc and content.

For each field of the template, there exists a field header, content and a hidden field attribute type that tells the VMMS client how to display and validate the user's input. For example, defined attributes may include: TEXT Any—String; TEXT Email Address—Email address that must have “@” and “.” characters in the string; TEXT Numeric—A number field; TEXT Phone—Phone number formatted string; TEXT URL—HTTP URL formatted string; TEXT Password—String that will display “*” instead of key in characters; TEXT Time—Time formatted string like: hh:mm; TEXT Date—Date formatted string like: yyyy/mm/dd.

Various steps can be implemented to edit field content, wherein the steps may vary according to the requirements of a particular handset vender. For example, the steps may include: Use up and/or down arrow to select an edit field; Press the ENTER button to enter the edit mode; Key in the content string; Press the ENTER button to exit the edit mode; and Select the SAVE button to exit the edit field content mode.

According to one embodiment, the VMMS client requires that the user type in or enter the full email address for the TEXT Email Address field. In another embodiment, the VMMS client allows a user to open up the Contact list, select the desired address(es), copy and then paste the copied address(es) into the TEXT Email Address field. When finished compiling the new mail, the user selects the SEND button to send it.

Delete Mail:

In one embodiment of the present disclosure, the VMMS client allows the user to delete one mail at a time, with a refresh command after every delete request. In another embodiment, the VMMS client provides a multiple mails delete feature.

Reply/Reply All Mail:

Upon request, the VMMS Client fetches a reply/reply all template from the VMMS server. Reply/Reply All mail is similar to the Create Mail template. In one embodiment, there are three (3) fields that are shown: cc, bcc and reply content. Once finished with desired editing, the user presses the REPLY button to request to reply to (or reply to all) the selected mail.

Forward Mail:

The VMMS Client fetches the forward template from the VMMS server. Forward Mail is similar to the Create Mail template. In one embodiment, there are four (4) fields that are shown: to, cc, bcc and new content. The user selects the REPLY button once finished entering the required fields to complete forwarding the selected mail.

Search Mail:

The VMMS Client fetches the search template from VMMS server. Search Mail is similar to the Create Mail template. In one embodiment, there are three (3) fields that are shown: subject, received date and from (sender). Upon received the search request, the VMMS server will logically AND all non-empty search fields for the search algorithm (empty search field will be ignored) and return the summary list of mails that matches the selected criteria.

Appointment Summary Listing (FIG. 5h—Appointment Summary Screen):

The header shows the selected date and how many appointments exist for the selected date. The appointment(s) are listed in the order of time: earliest appointment first. For each appointment, only the subject of the appointment is shown and its content is truncated to fit into one (1) line on the screen. All other associated data are hidden from the user. User Navigation is as follows: Move the highlight cursor to the desired mail to mark it as selected appointment. Select the ENTER button (e.g., the green phone icon or similar function key) to display the detail of the highlighted appointment item. Select the MENU button to: Create New Appointment; Delete Selected Appointment; Update to Selected Appointment; Search Appointment; and Exit application. In one embodiment, the VMMS client provides the user with the ability to filter (search) for appointments based on date, subject and location.

Appointment Detail Listing (FIG. 5i—Appointment Detail Screen):

The appointment's details consists of the following fields: subject, start time, end time, location and content. Each display field has two components, that is, a header and content. The content field is limited to <BufferSize> bytes.

Create New Appointment:

The VMMS Client fetches the new appointment template from the VMMS SERVER, similar to the Create Mail template. In one embodiment, there are five (5) fields that are shown: subject, start time, end time, location and content. When finished editing the appointment's data, the user selects the SAVE button to save the new appointment. In one embodiment, the VMMS client is configured to allow the user to select from the Contact list to select an available time slot for meeting and notify all attendees.

Delete Appointment:

Delete Appointment operates to delete appointments in a manner similar to Delete Mail.

Update Appointment:

The VMMS Client fetches the update appointment template from the VMMS SERVER, similarly as with the Create Mail template. In one embodiment, there are 5 fields that are shown: subject, start time, end time, location and content. These fields will be populated with the previously saved data. The user can modify content of these fields and press the Update button to send the update request to the VMMS server.

Search Appointment:

The VMMS Client fetches the search template from VMMS SERVER, similarly as with the Create Mail template. In one embodiment, there are 3 fields that are shown: subject, appointment date and location. See Search Mail for more details on the search algorithm. The VMMS SERVER returns the summary list of appointments that matches the selected criteria.

Appointment Alerter:

In one embodiment, the VMMS client supports sending an alert to the user's mobile device or mobile phone of an upcoming appointment.

Contact Summary Listing (FIG. 5j—Contact Summary Screen):

The header shows how many contacts exist for this user. The contact (s) are listed in the alphabetical order. For each contact, only the Last Name and First Name of the contact are shown and their content is truncated to fit into one (1) line on the screen. All other associated data are hidden from the user. User Navigation includes: Move the highlight cursor to the desired mail to mark it as selected contact. Select the ENTER button to display the detail of the highlighted contact item. Select the MENU button to: Create New Contact; Delete Selected Contact; Update to Selected Contact; Search Contact; and Exit application. In one embodiment, the VMMS client allows the user the ability to filter (search) for contacts based on first name and email address.

Contact Detail Listing (FIG. 5k—Contact Detail Screen):

The contact's details consist of the following fields: first name, last name, middle name, work address, work city, work state, home address, home city, home state, work phone, home phone and email.

Create New Contact:

The VMMS Client application fetches the new contact template from the VMMS server, similarly as with the Create Mail template. In one embodiment, there are 12 fields that are shown: first name, last name, middle name, work address, work city, work state, home address, home city, home state, work phone, home phone and email. When finished editing the contact's data, the user selects the SAVE button to save the new contact to the server.

Delete Contact:

Delete Contact operates to delete contacts in a manner similar to Delete Mail.

Update Contact:

The VMMS Client fetches the update contact template from the VMMS server, similarly as with the Create Mail template. In one embodiment, there are 12 fields that are shown: first name, last name, middle name, work address, work city, work state, home address, home city, home state, work phone, home phone and email. These fields are populated with the previously saved data.

Search Contact:

The VMMS Client fetches the search template from the VMMS server, similarly as with the Create Mail template. In one embodiment, there are two (2) fields that are shown: name, email. See Search Mail for more details on the search algorithm. The VMMS server returns the summary list of contacts that matches the criteria.

Note Summary Listing (FIG. 5l—Note Summary Screen):

The header shows how many notes exist for this user. The note content is shown and is truncated to fit into one (1) line on the screen. All other associated data are hidden from the user. User Navigation includes: Move the highlight cursor to the desired mail to mark it as selected notes. Select the ENTER button to display the detail of the highlighted notes item. Select the MENU button to: Create New Notes; Delete Selected Notes; Update to Selected Notes; or Exit application.

Note Detail Listing:

The note's detail consists of only one (1) field: content.

Create New Note:

The VMMS Client fetches the new note template from VMMS server similarly as with the Create Mail template. In one embodiment, there is only one (1) field that is shown: content. When finished editing the contact's content, the user selects the SAVE button to save the new note.

Delete Note:

Delete Note operates to delete notes in a similar manner as the Delete Mail feature.

Update Note:

The VMMS Client fetches the update contact template from the VMMS server, similarly as with the Create Mail template. In one embodiment, there is only one (1) field that is shown: content. This field is populated with the previously saved data.

In addition to the above features, tasks and appointments can also be implemented in a manner similar to the above features.

According to one embodiment, the VMMS fully utilizes BlueGrid™ client-server architecture, Java EJB, Microsoft Exchange™ and Lotus DominoÔ, POP3 Mail features. This embodiment provides performance, flexibility and ease of expansion of capabilities. Users can directly access email, appointments, contacts and other functions that are available in common mail servers, and in addition, are possible in real time.

According to another embodiment of wireless mobile messaging service architecture of the present disclosure, a packet protocol is defined for two types of packets, a detail packet and a summary packet. The detail packet includes a version, a packet field delimiter value, packet type value, item ID, header, status, field count, and field detail. The version includes any string value that indicates the packet version. The packet field delimiter value includes an integer value (2 bytes) that is divided into two parts, a first set of bits for identifying modification flags (bit-wise) and a second set of bits for enumerating the Packet ID type. Modification flags may include one or more of summary, new, update, delete, forward, reply, reply_all, look-up, as well as others, for example. The packet ID type may include an ID type enumerated for one or more of a folder, schedule, mail, note, contact, task, monthly summary, mail folder, default, or others, for example. The Item ID may include a string containing a unique ID of a detail object, for example, mail, contact, etc. The Header includes a string that is displayed by the client device. Status includes a “Passed” or “Failed” message. Field count and Field detail include the number of field records following and their formats, respectively. The Field detail format may includes a string of a field type, field name, and field value.

The summary packet includes a version, packet field delimiter value, packet type value, item ID, header, status, packet count, and detail packet. The version, packet field delimiter, packet type, item ID, header, and status are similar to that of the detail packet. The packet count refers to the number of packets to follow. The detail packet can be either a Detail or Summary Packet, depending upon a Summary flag.

The Client's side return packet shall now be briefly discussed. The EJB always returns to the Client in an array of String format, a Version, Packet Type (Modification flag+Packet Type), Item Id, Header, Status, Item Count, and then the first item, second item, etc. If Item count is zero (0), then the string array ends, else the string continues for the number of items in the item count.

With respect to the Client's side return packet, the item content depends on the packet type and the summary flag. If the summary flag is set, then each item contains a fully qualified packet. If the packet type is Folder request, then the item's packet is a summary packet. Or if the packet type is schedule summary, then the item's packet is detail packet. For example, in one embodiment, the Client sends the following packet to the Server: Default, Folder Summary, Mail Summary, Schedule Summary, Contact Summary, Note Summary, Mail Folder Summary, and Mail Detail. The Server responds with the same packet request and the appropriate result. For Schedule, Contact, and note, the details are also sent back inside the Summary Packet.

Special cases are noted as follows. With respect to the Folder Summary, the server returns a summary packet listing all the count for mails, schedules, contacts and notes with the item detail packet set to zero (0) count. With respect to the Mail Summary, the server returns a summary packet type equal to Mail Folder and the item packets will contain zero (0) fields. Accordingly, the client has to request Mail for each mail Id in order to display the mail contents. With respect to Mail Detail, the server will return a summary packet with one (1) packet in the item. The encapsulated packet will be a Mail detail packet with the appropriate number of fields.

The following is an illustrative example of packet process flow according to one embodiment of the present disclosure, wherein the mail server includes a Microsoft Exchange mail server. Responsive to a login by the Client, the Server performs a lookup of the user id from a database, using the username/password. The server then looks up the domain/Exchange folder from the database and using the User Id, performs a login to the Exchange Server. If successful, the server retrieves the last valid summary packet stored and its content's buffer size setting. The server then returns True or False to the client.

In response to the client submitting a request to send a default, the server responds as follows. If the last summary packet is not valid, then it returns the folder summary from Exchange to the Client. In addition, the server saves the folder summary as the default packet. Otherwise, the server performs one of the following: return mail summary from Exchange, or return schedule summary from Exchange, or return note summary from Exchange, or return contact from Exchange. In response to the client submitting a send folder request, the server returns a folder summary packet. Responsive to the client submitting a send mail summary, the server returns a mail folder summary packet. Responsive to the client submitting a send schedule packet, the server returns a schedule summary packet.

With respect to templates, a client can request a template for Mail, Schedule, Contact or Note, however, the client request would also need to send an appropriate packet with a NEW flag set in the package type field, Item Id=“0” and the item count=0. In response, the Server responds with the appropriate detail packet and the NEW flag cleared. The packet will be encapsulated inside a MAIL Summary packet with 1 Item count and the item is the detail packet itself.

According to one embodiment of the present disclosure, the wireless mobile platform provides wireless carriers, device makers, enterprises and wireless solution providers one or more of the following advantages: usage of standards-based technology, high performance, applicability to thousands of applications, proven technology and scalability, reduced device memory requirements, and convergence of different devices. With respect to standards-based technology, the wireless mobile platform is JAVA-based and enjoys all the JAVA advantages, including robust standards and long life. With respect to high performance, the thin client-server model reduces network dialog between wireless devices and applications, provides improved response time to the user and better utilizes the carrier's network bandwidth.

With respect to server-based messaging applications, there are literally thousands of applications that can be ported to the JAVA-based environment, providing carriers and enterprises numerous available applications for almost any requirement. With respect to proven technology and scalability, one embodiment of the present disclosure utilizes a Java platform (J2EE/J2ME Client/Server environment) and BlueGrid mobile Java communication middleware technology. With respect to mobile device memory, the client-server model of the present embodiments requires very small amounts of device memory, thus making devices either less expensive to produce or enables more features at the same price point. Lastly, with respect to convergence of devices, JAVA is an equalizer, that is, enabling convergence of PDA's and handsets, by providing a same look and feel to the user.

Carriers that deploy the wireless mobile platform of the present disclosure can receive one or more benefits. Such benefits include a competitive advantage and new sources of revenue. Incorporating the wireless mobile platform of the present disclosure into existing application web servers offers true mobile computing solutions that carrier or enterprise competitors cannot easily duplicate. For example, integrating the wireless mobile platform with existing wireless platforms offers rapid development of web services for mobile-commerce (m-commerce) portals, enabling carriers or enterprises to quickly extend portal services to subscribers or mobile users. More immediately, it delivers mobile access to corporate data with resulting productivity benefits. With respect to new sources of revenue, the wireless mobile platform of the present disclosure offers the ability to accelerate new revenue growth through the rapid introduction of useful new mobile applications and services, for example, by reducing time to market for new wireless solutions and reducing overall development costs. The wireless mobile platform solution offers a major opportunity to deliver true wireless applications and content to virtually all-wireless devices, thereby substantially increasing market share.

The wireless mobile platform solution includes an advanced mobile communications middleware, for example, BlueGrid, which supports easy development and scalable execution, enabling collaboration of J2ME CLDC (connected limited device configuration) and J2EE. Accordingly, a carrier or enterprise can develop scalable and highly reliable applications for virtually all wireless-specific devices with minimum development costs and a greatly reduced time to market or return.

The wireless mobile platform also includes an application suite supportive of mobile messaging for an enterprise. The application suite includes applications that enable mobile users to access not just e-mail, but also calendars, contacts, notes and tasks. Because the wireless mobile platform runs on the BlueGrid client-server wireless middleware technology, the application suite allows users to enjoy the full features and benefits of a respective application on a handset or PDA. Applications may include, for example, Microsoft Exchange, Lotus Domino, and others. The wireless mobile platform enables the full features of the respective application on a handset or PDA without requiring a browser. Accordingly, the wireless mobile platform ensures consistency, performance, and an ability to quickly upgrade without requiring handset or PDA changes.

Unlike other solutions where one can only access e-mail, the wireless mobile platform of the present embodiments also enables access to appointments, contacts, and any functions that are available in a respective messaging server application (e.g., Microsoft Exchange or Lotus Domino). Such access with the wireless mobile platform of the present embodiments is possible in real-time, offering a truly pleasant wireless Internet experience.

According to one embodiment, the wireless mobile messaging suite of software applications includes an Exchange mobile messaging client, a Notes mobile messaging client, a GroupWise mobile messaging client, and a mobile instant messaging client. The wireless mobile platform of the present disclosure also utilizes a thin-client approach. Accordingly, the mobile messaging client software resident on a mobile device occupies very little of the application memory on such devices. The mobile devices include, for example, cellular phones, PDA's and pocket PC's. In addition, each client is supported by a server component resident upon a web application server, the server component being included within the wireless mobile messaging suite of software.

With the wireless mobile platform architecture of the present disclosures, applications and content are centralized and automatically kept current without user intervention. Since both content and applications are server based, the content and applications are readily available for access anytime, anywhere and irrespective of mobile device and network. Wireless Internet access that is network agnostic, meaning Internet access is not dependent on a device or network, is a fundamental value of the wireless mobile platform of the present disclosure. Accordingly, the wireless mobile platform can be built to run on various wireless networks, such as GSM, CDMA, TDMA, and i-mode, among others, with MIDP protocols, as well as, DOJA (a Japanese version of MIDP).

In addition, if an enterprise or carrier maintains a website, applications, and Internet content completely secured in one or more application servers of its data center, then the enterprise or carrier can select a desired choice of wireless client device, be it a cellular phone or PDA, and is able to maintain reliable voice and data connectivity and communications between different networks and platforms. The wireless mobile platform of the present disclosure provides mobile users who want text-based messaging on their mobile device with the same freedom and unlimited access of voice communications.

The wireless mobile platform of the present disclosures is an innovative wireless solution that delivers access to applications and content, independent of the location or wireless device. The wireless mobile platform and mobile messaging architecture offers true wireless convergence. Features include accessing the same current information, no matter which device is used. Data becomes truly portable. According to one embodiment, the wireless mobile platform architecture is based on a Java J2ME CLDC MIDP profile, providing portability among various devices.

As discussed herein, wireless mobile messaging of the wireless mobile messaging platform is a Java “client-server” application that runs on BlueGrid communication middleware and J2EE/EJB environment. The wireless mobile messaging method enables mobile devices to access not just e-mail, but also calendars, contacts, notes and tasks from a corresponding messaging server or servers. The Java “client-server” application enables access to the full features and benefits of mail server applications, such as Microsoft Exchange, Lotus Domino, and many others, to become available on a handset or PDA.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A wireless mobile messaging system architecture, comprising:
a virtual mobile messaging service (VMMS) client adapted to run on a Java-enabled mobile device, the client including a user interface and a lightweight object request broker (ORB), the user interface for enabling input of a client request to a messaging server;
a virtual mobile messaging system (VMMS) component, said VMMS component including an enterprise Java beans (EJB) component and a mobile messaging server agent, wherein the EJB component is configured to operate on a Java application server to handle the client request to the messaging server via the mobile messaging server agent, the mobile messaging server agent configured to interface with the messaging server; and
a middleware server component adapted to support distributed object-oriented connectivity from the Java-enabled mobile device to the EJB component on the Java application server, the middleware server component including a gateway server adapted to support transparent access from the Java-enabled mobile device to the EJB component on the Java application server, and wherein the lightweight ORB enables communication between the client on the Java-enabled mobile device and the middleware server component on the Java application server.

2. The architecture of claim 1, wherein the EJB is configured to receive the client request from the middleware server in a string format.

3. The architecture of claim 2, wherein the middleware server includes a servlet, the servlet for converting the string formatted request to a Java object and for sending the converted Java request object to the mobile messaging server agent.

4. The architecture of claim 3, wherein the mobile messaging server client includes a VMMS client ActiveX component, and wherein the servlet sends a request in the form of a Java object to a JaWin DLL through a Java Native Interface (JNI), further wherein the JaWin DLL converts the received Java object to a C object and calls the VMMS client ActiveX component through a C function call.

5. The architecture of claim 1, wherein the messaging server includes a mail server.

6. The architecture of claim 5, wherein the mail server includes at least one selected from the group consisting of a Microsoftâ Exchangeâ server, an IBMâ Lotusâ Dominoâ server, a Novellâ GroupWiseâ server, a mail server system that supports POP3/SMTP, and a mail server system that supports IMAP/SMTP.

7. The architecture of claim 1, wherein the mobile messaging server agent includes an ActiveX component.

8. The architecture of claim 7, wherein the client request is in the form of a C object and wherein the VMMS client ActiveX component converts the received C object to a DOM object and sends the converted request in the form of the DOM object to the messaging server.

9. The architecture of claim 1, wherein the VMMS client uses HTTP as a communication protocol, and
wherein the gateway server runs in a servlet environment on the application server, the gateway server having a servlet acting as a gateway to translate protocols from HTTP to TCP/IP.

10. The architecture of claim 1, wherein the client uses a TCP/IP socket as its communication channel.

11. The architecture of claim 1, wherein the user interface includes a J2ME MIDP profile.

12. The architecture of claim 11, further wherein the MIDP profile version and Java version of the J2ME MIDP profile supports SSL.

13. The architecture of claim 1, wherein the VMMS component is configured to support HTTPS protocol.

14. The architecture of claim 1, wherein the VMMS client includes software that runs on the Java-enabled mobile device, requiring on the order of between 2-8K bytes of device memory.

15. The architecture of claim 14, wherein the VMMS client software is burned into a device chipset of the Java-enabled mobile device.

16. The architecture of claim 14, wherein the VMMS client software is downloadable from a website or via an over-the-air provisioning program to a device memory of the Java-enabled mobile device.

17. The architecture of claim 14, wherein the VMMS client software includes a graphical user interface (GUI) configured to enable browsing through multiple remote, over-the-air menus of a respective messaging server.

18. The architecture of claim 14, further wherein the VMMS client software is configured to run in a binary fashion.

19. A method for implementing a wireless mobile messaging system architecture, comprising:
providing a virtual mobile messaging service (VMMS) client to run on a Java-enabled mobile device, the client including a user interface and a lightweight object request broker (ORB), the user interface for enabling input of a client request to a messaging server;
providing a virtual mobile messaging system (VMMS) component via an enterprise Java beans (EJB) component and a mobile messaging server agent, including configuring the EJB component to operate on a Java application server to handle the client request to the messaging server via the mobile messaging server agent, the mobile messaging server agent configured to interface with the messaging server; and
adapting a middleware server component to support distributed object-oriented connectivity from the Java-enabled mobile device to the EJB component on the Java application server, the middleware server component including a gateway server for supporting transparent access from the Java-enabled mobile device to the EJB component on the Java application server, further including enabling communication between the client on the Java-enabled mobile device and the middleware server component on the Java application server via the lightweight ORB.

20. The method of claim 19, further comprising configuring the EJB to receive the client request from the middleware server in a string format.

21. The method of claim 20, wherein providing the middleware server includes converting the string formatted request to a Java object and sending the converted Java request object to the mobile messaging server agent via a servlet.

22. The method of claim 21, wherein the mobile messaging server agent includes an ActiveX component and wherein the servlet sends a request in the form of a Java object to a JaWin DLL through a Java Native Interface (JNI), further wherein the JaWin DLL converts the received Java object to a C object and calls a VMMS client ActiveX component through a C function call.

23. The method of claim 19, wherein the messaging server includes a mail server.

24. The method of claim 23, wherein the mail server includes at least one selected from the group consisting of a Microsoftâ Exchangeâ server, an IBMâ Lotusâ Dominoâ server, a Novellâ GroupWiseâ server, a mail server system that supports POP3/SMTP, and a mail server system that supports IMAP/SMTP.

25. The method of claim 19, wherein the mobile messaging server agent includes an ActiveX component.

26. The method of claim 25, further wherein the client request is in the form of a C object, further comprising converting the C-object to a DOM object via the VMMS client ActiveX component and sending the request in the form of a DOM object to the messaging server via the VMMS client ActiveX component.

27. The method of claim 19, further comprising using HTTP as a communication protocol for the VMMS client, and
running the gateway server in a servlet environment on the application server, the gateway server having a servlet acting as a gateway to translate protocols from HTTP to TCP/IP.

28. The method of claim 19, further comprising using a TCP/IP socket as a communication channel for the client.

29. The method of claim 19, wherein the user interface includes a J2ME MIDP profile.

30. The method of claim 29, further wherein the MIDP profile version and Java version of the J2ME MIDP profile supports SSL.

31. The method of claim 19, further comprising configuring the VMMS component to support HTTPS protocol.

32. The method of claim 19, wherein providing the VMMS client includes running software on the Java-enabled mobile device, the software requiring on the order of between 2-8K bytes of device memory.

33. The method of claim 32, further comprising burning the VMMS client software into a device chipset of the Java-enabled mobile device.

34. The method of claim 32, further comprising downloading the VMMS client software from a website or via an over-the-air provisioning program to a device memory of the Java-enabled mobile device.

35. The method of claim 32, wherein the VMMS client software includes a graphical user interface (GUI) configured to enable browsing through multiple remote, over-the-air menus of a respective messaging server.

36. The method of claim 32, further comprising configuring the VMMS client software to run in a binary fashion.
